(19) United States
(12) Patent Application Publication
(10) Pub. No.: US 2005/0170044 A1
(43) Pub. Date: Aug. 4, 2005

(54) Lactose-free milk and process for making same

(76) Inventor: Michel Lange, Saint Leonard (CA)

Correspondence Address: STIKEMAN ELLIOTT, 1600-50 O'CONNOR STREET, OTTAWA, ON, KIP LS2, CA

(21) Appl. No.: 11/050,853

(22) Filed: Jan. 27, 2005

(30) Foreign Application Priority Data
Feb. 3, 2004 (CA) 2,456,790

(51) Int. Cl. A23C 9/12

(52) U.S. Cl. 426/34

(57) ABSTRACT

A process for making lactose-free milk from milk containing lactose and protein, comprising the steps of filtering the milk to produce a permeate and a retentate containing solids and diluting the retentate to reduce the content of the solids.

### FIELD OF THE INVENTION

This invention relates to a lactose-free milk and a process for making same.

### BACKGROUND OF THE INVENTION

Since some individuals are intolerant to lactose, lactose-free milk products are available on the market. The lactose content of unprocessed cow's milk varies on average from 4.6% to 4.9% by weight. Milk is considered to be lactose-free if its lactose content is below a level detectable by enzymatic assays, which is below about 0.02%.

Since lactose is naturally occurring in milk, it must be reduced to produce a lactose-free milk. One well-known method for removing lactose from milk uses enzymatic hydrolysis whereby lactose is converted into its constituent monosaccharides, glucose and galactose using an enzyme. Glucose and galactose resulting from the hydrolysis of lactose are sweeter than lactose, and use of enzymatic hydrolysis alone results in a lactose-free milk which is sweeter than regular milk.

U.S. patent application Publication No. US2003/0031754A1, published on Feb. 13, 2003, discloses a process (hereinafter referred to as the “'754 process”) for making a lactose-free milk which is less sweet than that produced solely by enzymatic hydrolysis. The '754 process reduces the level of lactose in the milk being processed using a combined ultrafiltration and diafiltration step before the milk is subjected to enzymatic hydrolysis. The purpose of the ultrafiltration step is to retain milk fractions that have a molecular size which is greater than the porosity of the filter membrane. Diafiltration is carried out during the ultrafiltration in order to reduce the amount of lactose before hydrolysis is carried out.

The '754 process suffers from a number of disadvantages. The diafiltration step involves the addition of water during ultrafiltration and results in a larger volume of liquid comprising milk and water than the original milk volume. This larger volume of liquid when filtered, results in an increased volume of permeate that must be dehydrated or otherwise disposed of. The processing of such larger volumes increases production costs which leads to increased costs.

Thus, there is a need for an improved process for making lactose-free milk which overcomes the above-mentioned disadvantages.

### SUMMARY OF THE INVENTION

Accordingly, the invention relates to a process for making lactose-free milk from milk containing lactose and protein, comprising the steps of filtering the milk to produce a permeate and a retentate containing solids and followed by diluting the retentate to reduce the content of the solids; and subjecting the milk resulting from the diluting step to enzymatic hydrolysis.

In some embodiments, the filtering step is carried out using ultrafiltration.

In another embodiment, the invention relates to a lactose-free milk including about 0.48% by weight of a mineral.

In another embodiment, the invention relates to a dairy product including a lactose-free milk including a mineral content of about 0.48% by weight.

In another embodiment, the invention relates to a dairy product including a lactose-free milk where the milk contains about 4% by weight of a protein.

In another embodiment, the invention relates to a method for processing milk comprising the steps of filtering the milk to produce a permeate and a retentate, followed by diluting the retentate.

In another embodiment, the invention relates to a process for processing milk comprising steps of filtering the milk to produce a permeate and retentate followed by diluting the retentate to reduce the content of certain ingredients in the milk.

### BRIEF DESCRIPTION OF THE DRAWINGS

The invention is described below in greater detail with reference to the accompanying drawing, which is a flow chart showing both the prior art '754 process (in the broken line box) and the process according to the present invention. All percentage values are on a weight basis.

### DETAILED DESCRIPTION OF THE PREFERRED EMBODIMENTS

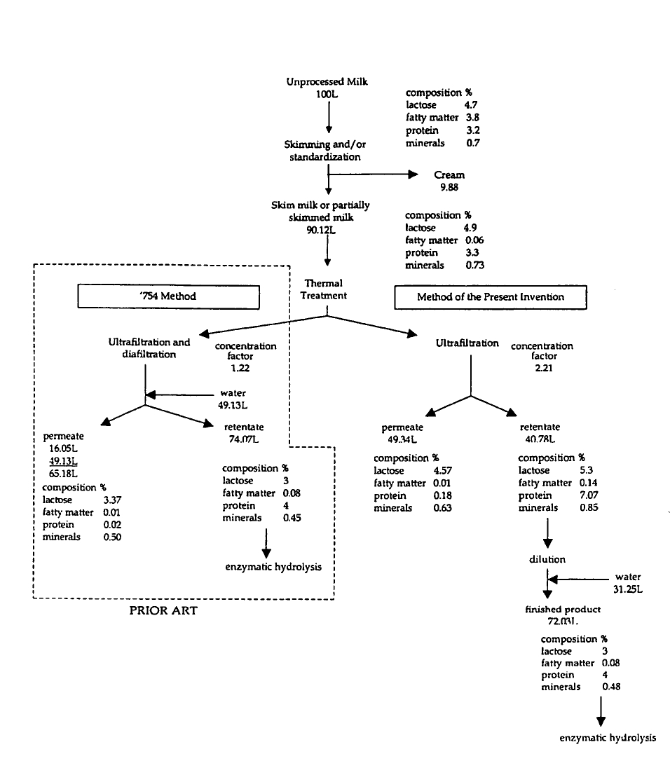

The steps of a process according to the present invention for making lactose-free milk will now be described with reference to the example in FIG. 1.

The protein content (Nx6.38) and the total fat matter content were determined in duplicate using the standard method of Kjeldahl and Mojonnier, respectively.

The lactose content was measured by a technique well known in the art, such as Boehringer & Mannheim Enzymatic Method.

In this example, the process begins with 100 L of unprocessed cow's milk, although it will be understood to those skilled in the art that the invention is useable with other starting volumes. It is well known that the composition of milk can vary depending on the season but for the purposes of the following example, cow's milk having a starting composition (on a dry weight percentage basis) of:

| | |
|---|---|
| lactose | 4.7% |
| fatty matter | 3.8% |
| proteins | 3.2% |
| minerals | 0.7% |

is used.

The cow's milk is subjected to an optional fat standardization to remove some or all of the fatty matter of the milk using known separation devices and methods. During such standardization, the desired content of fatty matter in the resulting milk is selected. A fatty matter content between 0% and 3.3% on a dry weight basis is preferred. It will be understood by those skilled in the art that the final fat content may vary by about 0.05% from the standardized fat content. In the Province of Quebec, Canada, milk is classified by percentage of fatty matter content as follows: 0.05%-0.1% (skim), 1%, 2% and 3.25%. In this example, the process was carried out using skim milk but is equally applicable for milk having a higher fatty matter content. For example, to produce a lactose-free homogenized milk, the fatty matter content is standardized to between 2.4% and 2.6% before ultrafiltration. In this example, the separation step resulted in 90.12 L of standardized milk with a composition of:

| | |
|---|---|
| lactose | 4.9% |
| fatty matter | 0.06% |
| proteins | 3.3% |
| minerals | 0.73% |

The standardized milk is then subjected to an optional thermal treatment step using known processes to destroy pathogenic agents in the standardized milk. In this example, the standardized milk was subjected to thermal treatment at 72° C. for 16 seconds.

Following thermal treatment, the resulting milk is allowed to cool to a temperature suitable for the ultrafiltration step which should not exceed the maximum temperature suggested by the manufacturer of the filtration membrane being used. The filtration temperature affects the permeation speed during ultrafiltration. An increase of 1° C. results in about 2.5% increase in permeation speed.

The next step is an ultrafiltration step. The filtration temperature in this example was stabilized at 50° C.

The filtration system used was a Tetra Pak™ system with Koch PM50 hollow fibre membranes, and the filtration parameters were as follows:

| | |
|---|---|
| Temperature | 50° C. |
| Transmembrane pressure | 1.0 Bar |
| pressure | 2.0 Bar |
| Velocity | ≧7 meters/second |
| Permeation speed | 30 L/m²/hr. |

It will be understood to those skilled in the art that other suitable filtration systems and membranes can be used which are capable of passing lactose with the permeate.

During the ultrafiltration step more protein is retained than lactose. The preferred ratio of lactose to protein in the retentate following ultrafiltration is about 1:1.3. This ratio is achieved in this example by using a concentration factor of 2.21. The ultrafiltration step yielded 49.34 L of permeate and 40.78 L of retentate. The composition of the permeate was:

| | |
|---|---|
| lactose | 4.57% |
| fatty matter | 0.00% |
| proteins | 0.18% |
| minerals | 0.63% |

The composition of the retentate was:

| | |
|---|---|
| lactose | 5.3% |
| fatty matter | 0.14% |
| proteins | 7.07% |
| minerals | 0.85% |

At a rate of 25 L/m²/hour, the 49.34 L of permeate can be filtered in 1.97 hours in the ultrafiltration step. It will be understood by those skilled in the art that the rate of filtration can be varied as a function of the size of the filter membrane used and by varying the parameters of temperature and pressure.

The retentate volume is 45.25% of the pre-filtered volume, the pre-filtered volume having been reduced by a concentration factor of 2.21.

The retentate was then diluted with 31.25 L of water to lower the concentration of lactose to about 3% which yielded 72.03 L of milk having a composition of:

| | |
|---|---|
| laclose | 3.0% |
| fatty matter | 0.08% |
| proteins | 4.0% |
| minerals | 0.48% |

When the lactose content is reduced to about 3%, the conversion of residual lactose into monosaccharides will result in the production of a lactose-free milk with an unnoticeable change in sweetness as compared to milk with the usual lactose content.

In the next step, the milk undergoes enzymatic hydrolysis using conventional methods to convert the remaining lactose to glucose and galactose. The resulting milk can then be heat treated by, but not limited to, pasteurization or U.H.T. and put into consumer packaging.

The process of the present invention yielded a milk product having a relatively high mineral level. Referring again to the accompanying drawing, the retentate of the '754 process contains 0.45% minerals, including calcium. In the present case the retentate contains 0.48% minerals.

Different concentrating factors can be used depending upon the starting composition of the milk and the desired final composition.

In a further embodiment of the invention, the enzymatic hydrolysis step can be carried out in consumer packaging (such as a milk carton) by combining milk with a lactose content of about 3% and an appropriate enzyme such that the hydrolysis takes place in the packaging.

The method of the present invention can also be used for filtering milk for purposes other than to reduce the lactose content where it is desired to alter the content of other fractions in milk, for example to alter the omega 3 content of milk.

The process of the present invention can also be used to produce lactose-free milk from other animal milk containing lactose such as goat's milk.

The milk produced by the process of the present invention is usable in dairy products such as yogurt and cheese, as well as other products which include milk in the same way as regular milk.

In another embodiment of the invention, nanofiltration (NF) or microfiltration (MF) methods may be used instead of ultrafiltration depending on the molecular size of the milk fractions whose content it is desired to alter.

1. A process for processing milk comprising the steps of:
(a) filtering the milk to produce a permeate and a retentate containing solids; and
(b) diluting the retentate to reduce the percentage of solids therein.

2. A process according to claim 1, wherein the milk contains lactose and protein, whereby the diluting step results in a lactose-free milk.

3. A process according to claim 2 including the step of subjecting the milk resulting from the diluting step to enzymatic hydrolysis.

4. A process according to claim 1, wherein the filtering step is carried out using a method selected from the group comprising ultrafiltration, nanofiltration and microfiltration.

5. A process according to claim 2, wherein the solids in the retentate include more protein than lactose on a percentage weight basis.

6. A process according to claim 5, wherein the retentate from the filtering step contains lactose and protein in a ratio of about 1:1.3.

7. A process according to claim 5 wherein, in the diluting step, the lactose content is reduced to about 3% by weight.

8. A process according to claim 1 including the step of standardizing the fatty matter content of the original milk prior to the filtering step to yield a standardized milk.

9. A process according to claim 8 including the step of thermally treating the standardized milk.

10. A process according to claim 3, wherein a lactose enzyme is used in the hydrolysis step until conversion of lactose into glucose and galactose is substantially complete.

11. A process according to claim 3 wherein the hydrolysis step is carried out in a consumer package.

12. A lactose-free milk including about 0.48% by weight of a mineral.

13. The lactose-free milk of claim 12 including about 4% by weight of a protein.

14. A lactose-free milk including about 4% by weight of a protein.

15. A process according to claim 1, wherein water is used in the dilution step.
